(19) United States
(12) Patent Application Publication
(10) Pub. No.: US 2009/0313075 A1
(43) Pub. Date: Dec. 17, 2009

(54) SYSTEM AND METHOD FOR ADAPTIVE SCHEDULING

(76) Inventors: PATRICK JOSEPH O'SULLIVAN, Ballsbridge (IE); Hema Srikanth, Raleigh, NC (US); Carol Sue Zimmet, Boxborough, MA (US); Sean Callanan, Churchtown (IE)

Correspondence Address: HOLLAND & KNIGHT, 10 ST. JAMES AVENUE, BOSTON, MA, 02116-3889, US

(21) Appl. No.: 12/137,840

(22) Filed: Jun. 12, 2008

(51) Int. Cl. G06Q 10/00

(52) U.S. Cl. 705/9

(57) ABSTRACT

A method and computer program product for receiving a scheduling request for a specified time slot. An acceptance of the scheduling request is received. One or more additional time slots associated with the specified time slot are scheduled.

### TECHNICAL FIELD

This disclosure relates to electronic calendaring systems, and more particularly to electronic calendaring systems allowing for adaptive scheduling.

### BACKGROUND

In the present internet and electronic communications age, electronic scheduling is an increasingly prevalent means for coordinating meetings, especially because it allows the same event scheduling message to be easily sent to a large group of people. However, unlike conventional paper calendaring, electronic scheduling presents challenges for calendaring any appropriate preparation and overflow time. For example, an individual may receive an invitation for a meeting during a specified time. Once the meeting is accepted (either automatically, or by the user) the time slot corresponding to the meeting may be indicated as occupied for that user. While this may prevent double-booking of time slots, the individual's availability may be visible to others, who may also schedule meetings with the individual for time periods surrounding the other meeting. Quite quickly the individual's calendar may become scheduled with back-to-back meetings. Tight scheduling of meetings may leave the individual without the opportunity to accommodate preparation time for any of the meetings, or overrun of any of the meetings, which may last longer than the scheduled time period.

### SUMMARY OF THE DISCLOSURE

In a first implementation, a method includes receiving a scheduling request for a specified time slot. An acceptance of the scheduling request is received. One or more additional time slots are scheduled associated with the specified time slot.

One or more of the following features may be included. Scheduling the one or more additional time slots may include analyzing one or more attributes of the scheduling request. An attribute of the scheduling request may include determining a participation status of a requested attendee. Another attribute of the scheduling request may include determining a likelihood of an overrun based upon, at least in part, one or more meeting attendees. A further attribute of the scheduling request may include analyzing a hierarchal relationship of the requested attendee and one more meeting attendees.

The one or more additional time slots may include one or more of a time period before the specified time slot and a time period following the specified time slot. Determining a likelihood of an overrun may include analyzing one or more previous scheduling activities including the requested attendee and one more meeting attendees. A pattern of scheduling activity for the requested attendee and the one or more meeting attendees may be defined based upon, at least in part, the one or more previous scheduling activities of the requested attendee. The scheduling request may be compared to the pattern of scheduling activity.

The requested attendee may be notified of the one or more additional time slots associated with the specified time slot. Notifying the requested attendee of the one or more additional time slots may include providing a prompt enabling the requested attendee to one or more of accept and decline the one or more time slots. Scheduling the one or more additional time slots may include recommending the one or more additional time slots to the requested attendee. Scheduling the one or more additional time slots may include scheduling the one or more additional time slots adjacent to the specified time slot. Scheduling the one or more additional time slots may include enabling timing selection of the one or more additional time slots. A notification of the scheduling of the one or more additional time slots may be provided.

According to another implementation, a computer program product resides on a computer readable medium, having a plurality of instructions stored on it. When executed by a processor, the instructions cause the processor to perform operations including receiving a scheduling request for a specified time slot. The instructions further cause the processor to receive an acceptance of the scheduling request. The instructions also cause the processor to schedule one or more additional time slots associated with the specified time slot.

One or more of the following features may be included. Scheduling the one or more additional time slots may include analyzing one or more attributes of the scheduling request. An attribute of the scheduling request may include determining a participation status of a requested attendee. Another attribute of the scheduling request may include determining a likelihood of an overrun based upon, at least in part, one or more meeting attendees. A further attribute of the scheduling request may include analyzing a hierarchal relationship of the requested attendee and one more meeting attendees.

The one or more additional time slots may include one or more of a time period before the specified time slot and a time period following the specified time slot. Determining a likelihood of an overrun may include analyzing one or more previous scheduling activities including the requested attendee and one more meeting attendees. The instructions may further cause the processor to define a pattern of scheduling activity for the requested attendee and the one or more meeting attendees based upon, at least in part, the one or more previous scheduling activities of the requested attendee. The instructions may further cause the processor to compare the scheduling request to the pattern of scheduling activity.

The instructions may further cause the processor to notify the requested attendee of the one or more additional time slots associated with the specified time slot. Notifying the requested attendee of the one or more additional time slots may include providing a prompt enabling the requested attendee to one or more of accept and decline the one or more time slots. Scheduling the one or more additional time slots may include recommending the one or more additional time slots to requested attendee. Scheduling the one or more additional time slots may include scheduling the one or more additional time slots adjacent to the specified time slot. Scheduling the one or more additional time slots may include enabling timing selection of the one or more additional time slots. The instructions may further cause the processor to provide a notification of the scheduling of the one or more additional time slots.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts an adaptive scheduling process and an electronic scheduling application coupled to a distributed computing network.

FIG. 2 is a flowchart of a process executed by the adaptive scheduling process of FIG. 1.

FIG. 3 is a diagrammatic view of scheduling request provided by the adaptive scheduling process and/or the electronic scheduling application of FIG. 1.

FIG. 4 is a diagrammatic view of a calendar and additional time slot prompt provided by the adaptive scheduling process and/or the electronic scheduling application of FIG. 1.

FIG. 5 is a diagrammatic view of a calendar including additional time slots scheduled by the adaptive scheduling process and/or the electronic scheduling application of FIG. 1.

### DETAILED DESCRIPTION

### System Overview

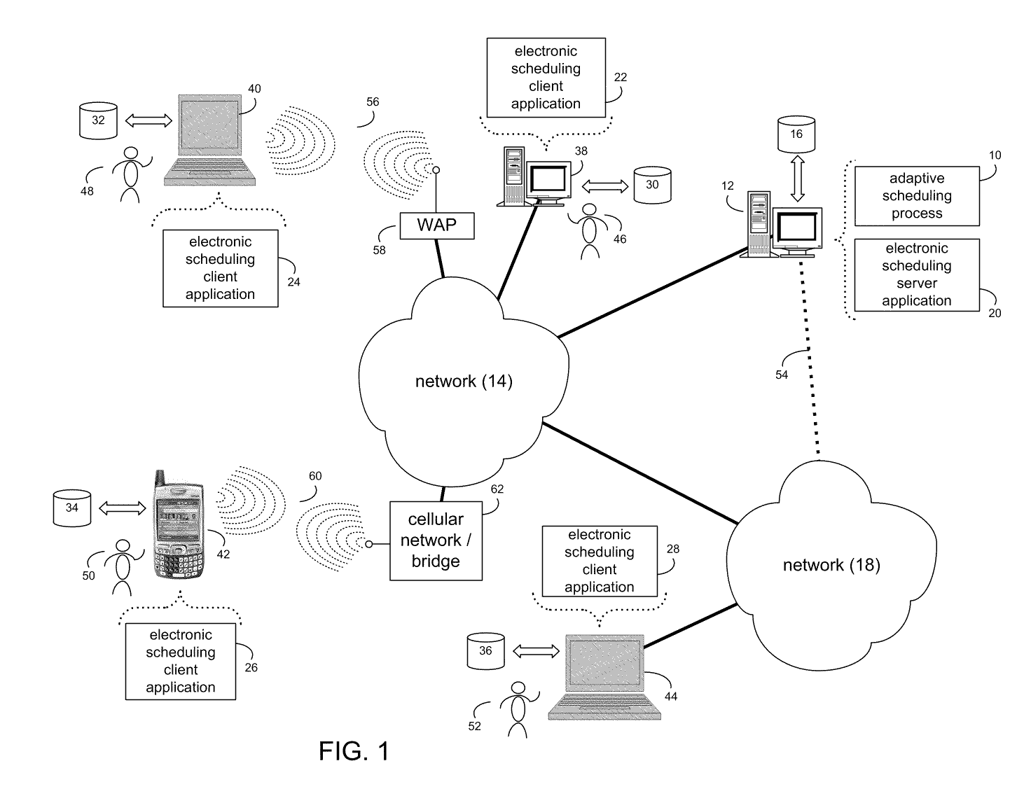

Referring to FIG. 1, there is shown adaptive scheduling process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, the adaptive scheduling process may reside on a client electronic device, such as a personal computer, notebook computer, personal digital assistant, or the like. In addition to being a server-based process, the adaptive scheduling process may be a client-side process, which may reside on, and be executed by, one or more client electronic devices.

As will be discussed below in greater detail, adaptive scheduling process 10 may receive a scheduling request for a specified time slot. An acceptance of the scheduling request may be received. One or more additional time slots may be scheduled associated with the specified time slot.

The instruction sets and subroutines of adaptive scheduling process 10, which may include one or more software modules, and which may be stored on storage device 16 coupled to server computer 12, may be executed by one or more processors (not shown) and one or more memory architectures (not shown) incorporated into server computer 12. Storage device 16 may include but is not limited to: a hard disk drive; a solid state drive, a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more electronic scheduling server applications (e.g., electronic scheduling server application 20), examples of which may include but are not limited to, e.g., Lotus Domino™ Server and Microsoft Exchange™ Server. Electronic scheduling server application 20 may interact with one or more electronic scheduling client applications (e.g., electronic scheduling client applications 22, 24, 26, 28) for routing and managing electronic scheduling communications (e.g., invitations and acceptances) and events. Examples of electronic scheduling client applications 22, 24, 26, 28 may include, but are not limited to, e.g., Lotus Notes™ and Microsoft Outlook™. Adaptive scheduling process 10 may be a stand-alone application that interfaces with electronic scheduling server application 20 or may be an applet/application that is executed within electronic scheduling server application 20.

The instruction sets and subroutines of electronic scheduling server application 20, which may be stored on storage device 16 coupled to server computer 12, may be executed by one or more processors (not shown) and one or more memory architectures (not shown) incorporated into server computer 12.

As mentioned above, in addition/as an alternative to being a server-based application residing on server computer 12, the adaptive scheduling process may be a client-side application (not shown) residing on one or more client electronic devices 38, 40, 42, 44 (e.g., stored on storage devices 30, 32, 34, 36, respectively). As such, the adaptive scheduling process may be a stand-alone application that interfaces with an electronic scheduling client application (e.g., email client applications 22, 24, 26, 28), or may be an applet/application that is executed within an electronic scheduling client application. As such, the adaptive scheduling process may be a client-side process, a server-side process, or a hybrid client-side/server-side process, which may be executed, in whole or in part, by server computer 12, or one or more of client electronic devices 38, 40, 42, 44.

The instruction sets and subroutines of electronic scheduling client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; solid state drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using electronic scheduling client applications 22, 24, 26, 28, users 46, 48, 50, 52 may send scheduling invitations, receive scheduling invitations, accept scheduling invitations, manage schedules meetings/events, etc. Sending, receiving, accepting scheduling invitations, and managing scheduling meetings/events may include accessing and/or interacting with electronic scheduling server application 20.

Users 46, 48, 50, 52 may access electronic scheduling server application 20 directly through the device on which the electronic scheduling client application (e.g., electronic scheduling client applications 22, 24, 26, 28) is executed, namely client electronic devices 38, 40, 42, 44, for example. Users 46, 48, 50, 52 may access electronic scheduling server application 20 directly through network 14 or through secondary network 18. Further, server computer 12 (i.e., the computer that executes electronic scheduling server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Adaptive Scheduling Process

For illustrative purposes, electronic scheduling client application 22 will be discussed. However, this should not be construed as a limitation of the present disclosure, as other electronic scheduling client applications (e.g., electronic scheduling client applications 24, 26, 28) may be equally utilized.

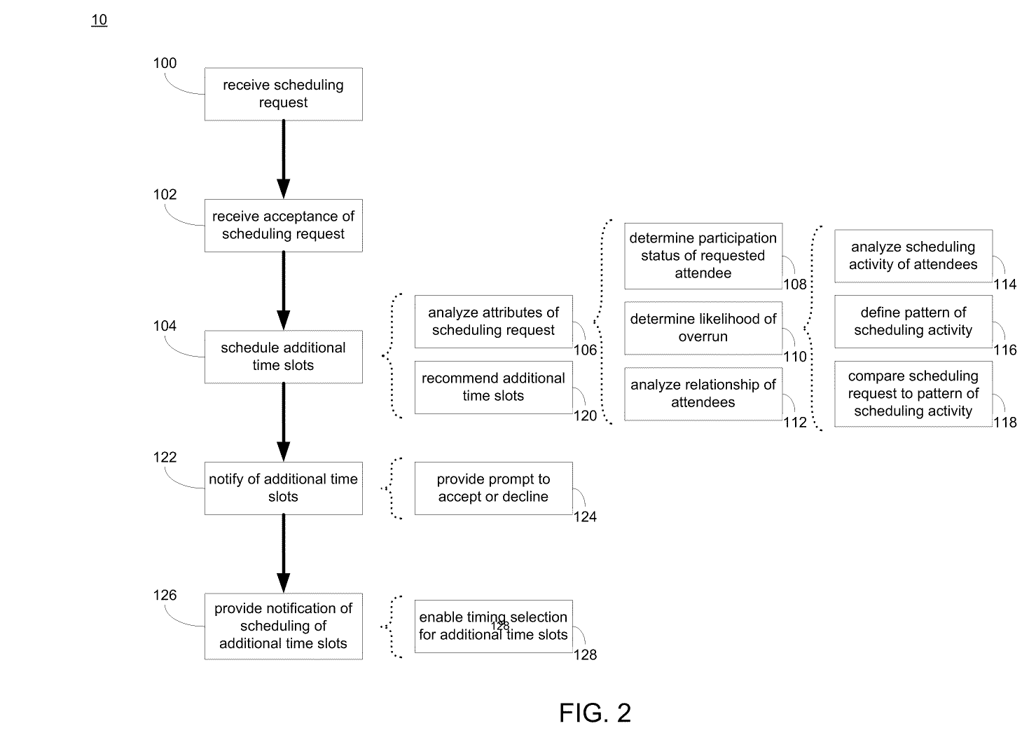

Referring also to FIG. 2, adaptive scheduling process 10 may receive 100 a scheduling request for a specified time slot. Adaptive scheduling process 10 may further receive 102 an acceptance of the scheduling request. One or more additional time slots may be scheduled 104, which may be associated with the specified time slot.

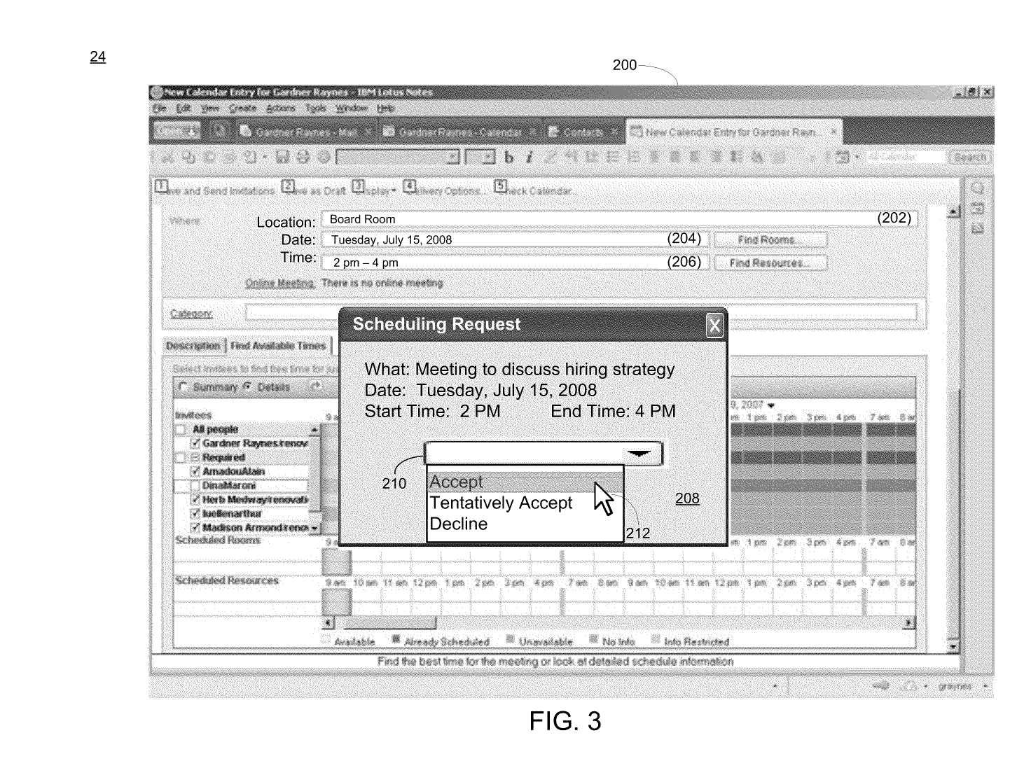

For example, and with reference also to FIG. 3, scheduling request 200 may be sent (e.g., via electronic scheduling server application 20 and/or one or more electronic scheduling client applications 24, 26, 28) to a requested invitee (e.g., user 46). Scheduling request 200 may be received by user 46, e.g., and may be rendered by electronic scheduling application 22. Scheduling request 200 may include location field 202 (e.g., which may specify a location of a proposed event, such as a meeting), date field 204, and time field 206 (e.g., which may respectively specify the date and time of the proposed meeting, namely Tuesday, Jul. 15, 2008 from 2 pm to 4 pm). Adaptive scheduling process 10 may receive 100 (e.g., via one or more of electronic scheduling server application 20 and/or electronic scheduling client application 22) scheduling request 200 for the specified time slot (e.g., which may include the date and time specified in date filed 204 and time field 206).

Continuing with the above-stated example, electronic scheduling client application 22 (alone or in conjunction with electronic scheduling server application 22) may render response window 208. Response window 208 may include pull-down menu 210 including various acceptance options (namely “Accept”, “Tentatively Accept”, and “Decline”). While pull-down menu 210 is shown only including three options, this should not be construed as a limitation of this disclosure, as the number and nature of the options included within pull-down menu 210 may vary according to user need and design criteria.

User 46 may accept the requested meeting by selecting, via onscreen pointer 212 (e.g., which may be controlled by a pointing device, such as a mouse; not shown). Upon user 46 selecting “Accept” from pull-down menu 210, the acceptance of scheduling request 200 may be transmitted to electronic scheduling server application 20 (e.g., and one or more of electronic scheduling client applications 24, 26, 28 that may be associated with, for example, the user requesting the meeting). Additionally/alternatively, depending upon preferences defined for user 46 and/or for system-wide implementation, scheduling request 200 may be automatically accepted (e.g., user 46 may not be required to affirmatively accept scheduling request 200) if the time slot defined by date field 204 and time field 206 do not present a conflict with an existing scheduling event. Further, adaptive scheduling process 10 may receive 102 (e.g., via electronic scheduling client application 22 and/or electronic scheduling server application 20) an acceptance of scheduling request 200.

Based upon, at least in part, the received 100 scheduling request, and the received 102 acceptance of the scheduling request for a specified time slot, adaptive scheduling process 10 may schedule 104 one or more additional time slots, e.g., which may be associated with the specified time slot. The one or more additional time slots may include, for example, one or more of a time period before the specified time slot of the proposed meeting (e.g., which may provide preparation time for the proposed meeting) and a time period following the specified time slot of the proposed meeting (e.g., which may provide for the possibility that the proposed meeting may overrun the specified time slot). As such, one or more of the additional time slots may include an additional time slot adjacent to the specified time slot of the meeting. For example, an additional time slot scheduled 104 to accommodate an overrun of the meeting may be scheduled in an additional time slot immediately following the specified time slot of the meeting. Further, an additional time slot, e.g., to allow for preparation for the meeting may be scheduled 104 either immediately before the specified time slot for the meeting, or at any time therebefore.

Scheduling 104 the one or more additional time slots may include analyzing 106 one or more attributes of the scheduling request. Analyzing 106 one or more attributes of the scheduling request may include one or more of determining 108 a participation status of a requested attendee, determining 110 a likelihood of an overrun based upon, at least in part, one or more meeting attendees, and analyzing 112 a hierarchical relationship of the requested attendee and one or more meeting attendees.

Further, adaptive scheduling process 10 may analyze 106 the attributes of scheduling request 200, and may determine 108 a participation status of a requested attendee (e.g., user 46). For example, user 46 may be designated as a required attendee of the proposed meeting. User 46's status as a required attendee may be indicative of more than an mere observer. As such, adaptive scheduling process 10 may schedule one or more additional time slots for meeting preparation. Further, user 46's participation status may be determined 108 by reference to, at least in part, an organizational structure, such as group or team membership (e.g., which may be determined by reference to an organizational directory, such as a corporate LDAP; not shown). For example, user 46 may be a team leader, and the proposed meeting may be a team meeting. As such, adaptive scheduling process 10 may determine 108 that user 46 may be a major contributor for the team meeting. As such, adaptive scheduling process 10 may schedule 104 one or more additional time slots, e.g., to allow for preparation time.

As mentioned above, adaptive scheduling process 10 may analyze 106 attributes of scheduling request 200, which may include determining 110 a likelihood of the proposed meeting overrunning the specified time slot of the proposed meeting based upon, at least in part, one or more meeting attendees. For example, meetings including Mark as an attendee may frequently overrun the scheduled time slot for the meeting, e.g., as may be discerned by telephone logs (e.g., in the case of a telephonic meeting), net meeting logs (e.g., in the case of a web based meeting), missed subsequent meetings, etc. Accordingly, based upon, at least in part, Mark being a meeting attendee of the proposed meeting, adaptive scheduling process 10 may determine 110 a high likelihood of an overrun, and may schedule 104 one or more additional time slots associated with the specified time slot for the proposed meeting. Similarly, meetings including John and Allison as meeting attendees may historically overrun the scheduled time period unless Toni is also included as a meeting attendee. Accordingly, if scheduling request includes both John and Allison as meeting attendees, but does not include Toni as a meeting attendee, adaptive scheduling process 10 may determine 110 that there is a high likelihood of an overrun, and may, accordingly, schedule 104 one or more additional time slots associated with the specified time slot for the proposed meeting. Various similar trends for meetings that overrun, or do not overrun, may provide a basis for adaptive scheduling process 10 determining 110 a likelihood of an overrun.

Continuing with the foregoing, in determining 110 the likelihood of an overrun, adaptive scheduling process 10 may analyze 114 one or more previous scheduling activities including the requested attendee and one more additional meeting attendees. Continuing with the above example, Michael is a required attendee, adaptive scheduling process 10 may analyze 114 previous scheduling activities and/or meeting histories for meetings that included Michael as a meeting attendee. If prior meetings including Michael as a meeting attendee typically lasted in excess of a scheduled time slot, then adaptive scheduling process 10 may determine 108 that there is a relatively high likelihood of an overrun (e.g., which likelihood may be based upon, at least in part, a historical percentage of meetings including Michael as a meeting attendee that lasted in excess of the scheduled time slot).

Adaptive scheduling process 10 may define 116 a pattern of scheduling activity for the requested attendee (e.g., user 46) and the one or more meeting attendees based upon, at least in part, the one or more previous scheduling activities of user 46. Trends or patterns indicating meeting overruns when certain meeting attendees are present may be established by analyzing previous scheduling activities and/or the meeting history for meetings including the one or more meeting attendees. Continuing with the above example, adaptive scheduling process 10 may analyze 114 the previous scheduling activity of user 46 and may define 116 a pattern of scheduling activity (e.g., 190% of meetings including user 46 and Michael overrun the scheduled time slot by fifteen minutes, 5% of meetings including user 46 and Toni overrun the scheduled time slot by 15 minutes, and the like). While percentage of meetings that overrun the scheduled time slot have been presented as an indicator of a pattern of meeting overruns, various additional and/or alternative metrics may be equally utilized.

Adaptive scheduling process 10 may compare 118 scheduling request 200 to the defined 116 pattern of scheduling activity. For example, scheduling request 200 may include Michael as a meeting attendee. Continuing with the above-stated example, defined 116 pattern of scheduling activity may indicate that 90% of meetings including user 46 and Michael may overrun the scheduled time slot by 15 minutes. Adaptive scheduling process 10 may compare 118 scheduling request 200 to the defined 116 pattern of scheduling activity (i.e., that meetings including user 46 and Michael overrun by 15 minutes 90% of the time) and may determine 110 that there is a high likelihood of an overrun. Accordingly, adaptive scheduling process 10 may schedule 104 one or more additional time slots.

Adaptive scheduling process 10 may analyze 112 a hierarchical relationship of the requested attendee (e.g., user 46) and one more meeting attendees. As discussed above, depending, e.g., upon defined preferences, the level of participation of a requested attendee may be indicated, at least in part, by the requested attendee's organization (e.g., hierarchical) relationship relative to one or more other meeting attendees. For example, user 46 may be a team leader (e.g., as indicated by information included within an organizational directory, such as a corporate LDAP). Additionally, the remaining meeting attendees may be members of user 46's team, having a lower hierarchical position than user 46. Based upon, at least in part, predefined preference, adaptive scheduling process may determine that user 46 may be a major participant in the meeting. Accordingly, adaptive scheduling process 10 may schedule one or more additional time slots associated with the specified time slot for the meeting (e.g., to allow for preparation time for user 46). While the preceding example presumes that a requested invitee having a higher hierarchical position than the other meeting attendees may have a more major role in the meeting, this is intended for illustrative purposes only. Various additional/alternative preferences may be defined (e.g., by the requested attendee, a system administrator, or the like).

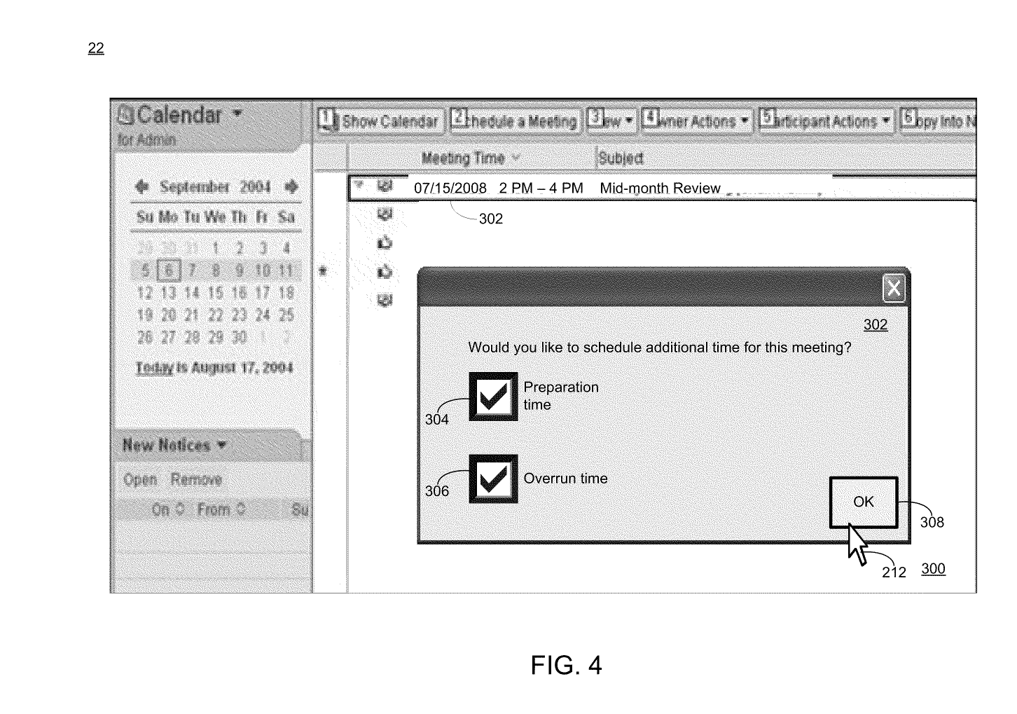

Scheduling 104 one or more additional time slots associated with the specified time slot for the meeting may include recommending 120 one or more additional time slots. For example, and referring also to FIG. 4, adaptive scheduling process 10 (alone or in conjunction with one or more of electronic scheduling client application 22 and/or electronic scheduling server application 20) may render scheduling interface 300 (e.g., in response to user 46 accepting scheduling request 200). Further, adaptive scheduling process 10 (alone or in conjunction with one or more of electronic scheduling client application 22 and/or electronic scheduling server application 20) may render pop-up 302, e.g., which may include a recommendation for preparation time and/or overrun time to be scheduled relative to the specified time slot for the proposed meeting.

Continuing with the above-stated example, in addition to recommending 120 additional time slots, adaptive scheduling process 10 may notify 122 user 46 of the one or more additional time slots. For example, pop-up 302 may include preparation time check box 304 and overrun time check box 306, e.g., each of which may be checked notifying user 46 that time slots for both preparation time and overrun time may be scheduled. Further, notifying the requested attendee (e.g., user 46) of the one or more additional time slots (e.g., a preparation time slot and an overrun time slot), adaptive scheduling process 10 may allow user 46 to accept or decline the one or more additional time slots. For example, user 46 may uncheck (e.g., by selecting via onscreen pointer 212) one or more of preparation time check box 106 and overrun time check box 306 to decline one or more of the additional time slots. Similarly, if only one additional time slot (e.g., for preparation time) is recommended 120 by adaptive scheduling process 10, user 46 may select, via onscreen pointer, overrun time check box 306, thereby also scheduling an overrun time slot. Once user 46 has made desired selections, user 46 may select, via onscreen pointer 212, ok button 308.

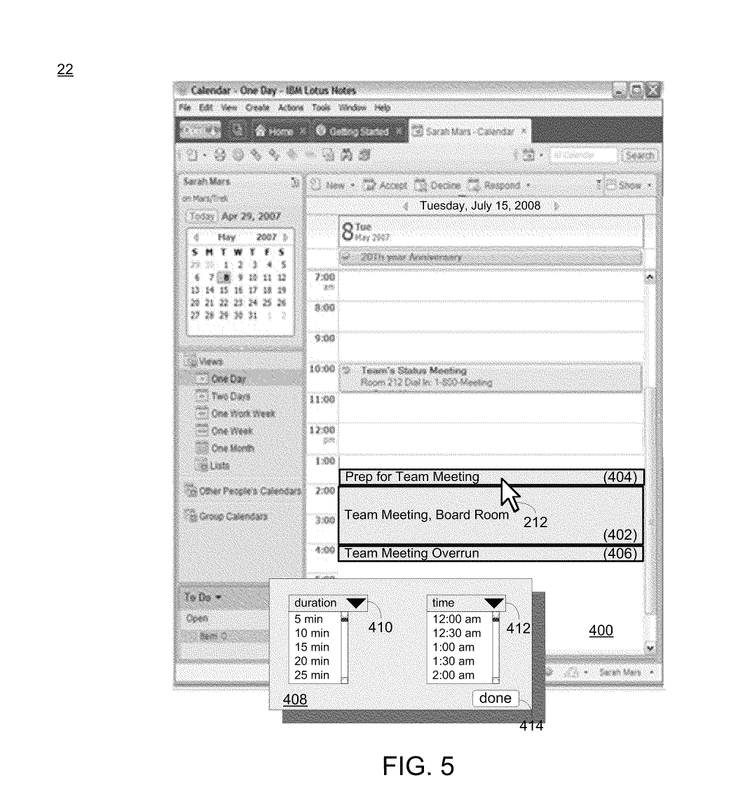

Adaptive scheduling process 10 may schedule 104 the one or more additional time slots adjacent to the specified time slot for the proposed meeting. Further, adaptive scheduling process 10 may provide 126 notification of the scheduling of the one or more additional time slots. For example, and referring also to FIG. 5, electronic scheduling client application 22 (alone or in conjunction with one or more of adaptive scheduling process 10 or electronic scheduling server application 20) may provide scheduling user interface 400. Scheduling user interface 400 may include specified time slot 402 for the proposed meeting (e.g., for “Team Meeting”). Additionally, scheduling user interface 400 may include one or more additional time slots, e.g., time slot 404 for “Prep for Team Meeting”, and time slot 406 for “Team Meeting Overrun”. As shown, the one or more additional time slots (e.g., time slots 404, 406) may be scheduled adjacent to the specified time slot 402 for “Team Meeting”.

Adaptive scheduling process 10 may further enable 128 timing selection of the one or more additional time slots (e.g., time slots 404, 406). For example, and with continued reference to FIG. 5, user 46 may select, e.g., via onscreen pointer 212, one or more of additional time slots 404, 406 and right-click on the selected additional time slot. Right-clicking on the selected additional time slot (e.g., time slot 404) may result in adaptive scheduling process 10 (alone or in conjunction with one or more of electronic scheduling client application 22 and/or electronic scheduling server application 20) rendering pop-up 408. Pop-up 408 may include timing selection options. For example, while adaptive scheduling process 10 may initially schedule time slot 404 adjacent to specified time slot 402 for the proposed meeting (e.g., for Team Meeting), adaptive scheduling process 10 may allow user 46 to change the duration and/or scheduling of time slot 404.

Continuing with the above-stated example, pop-up 408 may include duration pull-down 410 and time pull-down 412. User 46 may select a desired duration for time slot 404 by selecting, via onscreen pointer 212, a desired time duration for time slot 404 from duration pull-down 410. Similarly, if user does not wish time slot 404 to be immediately before specified time slot 402 for the proposed meeting, user 46 may select a desired timing parameter from time pull-down 412. Once user 46 has made desired timing selections from within pop-up 408, user 46 may select done button 414. Selecting done button 414 may result in adaptive scheduling process 10 modifying the one or more additional time slots (e.g., time slots 4040, 406) consistent with user 46's selections.

A number of implementations have been described. Nevertheless, it will be understood that various modifications may be made. Accordingly, other implementations are within the scope of the following claims.

What is claimed is:

1. A method comprising:
receiving a scheduling request for a specified time slot;
receiving an acceptance of the scheduling request; and
scheduling one or more additional time slots associated with the specified time slot.

2. The method of claim 1, wherein scheduling the one or more additional time slots includes analyzing one or more attributes of the scheduling request including one or more of:
determining a participation status of a requested attendee;
determining a likelihood of an overrun based upon, at least in part, one or more meeting attendees; and
analyzing a hierarchal relationship of the requested attendee and one more meeting attendees.

3. The method of claim 1, wherein the one or more additional time slots include one or more of a time period before the specified time slot and a time period following the specified time slot.

4. The method of claim 2, wherein determining a likelihood of an overrun includes:
analyzing one or more previous scheduling activities including the requested attendee and one more meeting attendees;
defining a pattern of scheduling activity for the requested attendee and the one or more meeting attendees based upon, at least in part, the one or more previous scheduling activities of the requested attendee; and
comparing the scheduling request to the pattern of scheduling activity.

5. The method of claim 1, further comprising notifying a requested attendee of the one or more additional time slots associated with the specified time slot.

6. The method of claim 5, wherein notifying the requested attendee of the one or more additional time slots includes providing a prompt enabling the requested attendee to one or more of accept and decline the one or more additional time slots.

7. The method of claim 1, wherein scheduling the one or more additional time slots includes recommending the one or more additional time slots to a requested attendee.

8. The method of claim 1, wherein scheduling the one or more additional time slots includes scheduling the one or more additional time slots adjacent to the specified time slot.

9. The method of claim 1, further comprising providing a notification of the scheduling of the one or more additional time slots.

10. The method of claim 9, wherein providing the notification of the one or more additional time slots includes enabling timing selection of the one or more additional time slots.

11. A computer program product residing on a computer readable medium having a plurality of instructions stored thereon which, when executed by a processor, cause the processor to perform operations comprising:
receiving a scheduling request for a specified time slot;
receiving an acceptance of the scheduling request; and
scheduling one or more additional time slots associated with the specified time slot.

12. The computer program product of claim 11, wherein scheduling the one or more additional time slots includes analyzing one or more attributes of the scheduling request including one or more of:
determining a participation status of a requested attendee;
determining a likelihood of an overrun based upon, at least in part, one or more meeting attendees; and
analyzing a hierarchal relationship of the requested attendee and one more meeting attendees.

13. The computer program product of claim 11, wherein the one or more additional time slots include one or more of a time period before the specified time slot and a time period following the specified time slot.

14. The computer program product of claim 12, wherein determining a likelihood of an overrun includes:
analyzing one or more previous scheduling activities including the requested attendee and one more meeting attendees;
defining a pattern of scheduling activity for the requested attendee and the one or more meeting attendees based upon, at least in part, the one or more previous scheduling activities of the requested attendee; and
comparing the scheduling request to the pattern of scheduling activity.

15. The computer program product of claim 11, further comprising notifying a requested attendee of the one or more additional time slots associated with the specified time slot.

16. The computer program product of claim 15, wherein notifying the requested attendee of the one or more additional time slots includes providing a prompt enabling the requested attendee to one or more of accept and decline the one or more additional time slots.

17. The computer program product of claim 11, wherein scheduling the one or more additional time slots includes recommending the one or more additional time slots to a requested attendee.

18. The computer program product of claim 11, wherein scheduling the one or more additional time slots includes scheduling the one or more additional time slots adjacent to the specified time slot.

19. The computer program product of claim 11, further comprising providing a notification of the scheduling of the one or more additional time slots.

20. The computer program product of claim 19, wherein providing the notification of the one or more additional time slots includes enabling timing selection of the one or more additional time slots.
